(19) United States
(12) Patent Application Publication
(10) Pub. No.: US 2016/0230448 A1
(43) Pub. Date: Aug. 11, 2016

(54) Removable Fall Prevention Device

(71) Applicant: INFINVALUE INC., Belize City (BZ)

(72) Inventor: TSUNG-HSUN HAN, New Taipei City (TW)

(21) Appl. No.: 15/016,225

(22) Filed: Feb. 4, 2016

(30) Foreign Application Priority Data
Feb. 4, 2015 (TW) 104201782

(51) Int. Cl. E06B 9/02

(52) U.S. Cl. CPC E06B 9/02; E06B 2009/002

(57) ABSTRACT

A configurable barrier assembly for installing into a window frame having an opening needs to prevent falling. The configurable barrier assembly includes two anchored frames for being installed on the two sides of the window frame respectively, a plurality of first movable sliders slidably coupled at one of the anchored frames in a detachably movable manner, a plurality of second movable sliders slidably coupled at another anchored frame in a detachably movable manner, and a plurality of anti-falling cords. The first and second movable sliders are formed in pair that each of the anti-falling cords is extended between the first and second movable sliders in each pair, such that the anti-falling cords are extended between the anchored frames in a tension manner to form a barrier. The configurable barrier assembly is removable when detaching the and second movable sliders from the anchored frames.

### NOTICE OF COPYRIGHT

A portion of the disclosure of this patent document contains material which is subject to copyright protection. The copyright owner has no objection to any reproduction by anyone of the patent disclosure, as it appears in the United States Patent and Trademark Office patent files or records, but otherwise reserves all copyright rights whatsoever.

### BACKGROUND OF THE PRESENT INVENTION

1. Field of Invention

The present invention is related to a fence structure, in particular to a configurable barrier assembly that applies to all kinds of places for prevent falling, such as balcony, patio, and window frame, and that allow rapid installation and uninstallation, so as to prevent children from accidentally falling out from a building, to keep air circulation of indoor spaces, and to avoid influences on the view.

2. Description of Related Arts

Accidents of children falling out from building happen all over the world because most families live in high-rise buildings and most apartments have multiple windows or balconies. As a result, young children may accidentally fall as they climb over the windows or balconies. In order to prevent such accident, a solution is to add bars, grille, or affixed cable on the outer side of the windows, so as to prevent young children from falling out the building as they climb over the window.

However, bars at the outer sides of the windows and balcony can block people from evacuation and block the view. Although grille can be opened for evacuation, it will also block the view. In addition the grille will form a barrier cage that people cannot fully enjoy the beautiful view and will also destroy the aesthetics and ventilation of the building. Besides, concealing bars are not commonly used because they are not movable and need to be cut with special tools for evacuation when there is a fire.

Further, affixed bar shape, grid shape, or numeral steel cables are considered as the common anti-falling devices. Once they are installed, they cannot be removed easily. In case of fire or other accidents, the anti-falling devices become obstacle for evacuation. Meanwhile, the affixed installation not only blocks the view but also provides an obstacle to block the user to clean the screen and window.

Therefore, the present invention provides a way of creating a movable anti-falling device, which simplifies the structural configuration, is easy for installation, is rapidly removable or dissemble when it becomes unnecessary or in case of fire, is free from influencing evacuation or view, so as to allow the user to freely decide to remove the anti-falling device easily when there is no concern of falling (e.g. when the window is closed), so as to enhance the overall practicability of the device.

### SUMMARY OF THE PRESENT INVENTION

An objective of the present invention is to provide a configurable barrier assembly as an anti-falling device to be installed at various places that need to prevent falling, such as top and bottom sides or left and right sides of a balcony, patio, or window frame, rapidly based on the needs, and to be rapidly removed when it becomes unwanted, which not only achieves the purpose of anti-falling, but also keeps from influencing the evacuation and view, so as to have a better overall practicability.

In order to achieve the above objects, the present invention provides a configurable barrier assembly to be used for places that need to prevent falling, such as top and bottom sides or left and right sides of a window frame. The configurable barrier assembly includes a pair of anchored frames, a plurality of first movable sliders, a plurality of second movable sliders, and a plurality of anti-falling cords. The anchored frames are respectively set on both of the top and bottom sides or both of the left and right sides. One end of the anti-falling cord is attached on the first movable slider, while the other end is attached on the second movable slider. The first movable sliders are slidably aligned at a side of one of the anchored frames, while the second movable sliders are sliding aligned at a side of the other anchored frame.

In a preferred embodiment, the anchored frames are integrally set on the left and right sides of a window frame. The first movable slider and the second movable slider are respectively are formed in cylindrical shape with a channel therewithin. A side of each of the first movable slider and the second movable slider has a perforation to communicate with the channel. An end of the anti-falling cord passes through the perforation of the first movable slider and is secured within the channel of the first movable slider. Then, the other end of the anti-falling cord passes through the perforation of the second movable slider and is secured within the channel of the second movable slider.

In another preferred embodiment, the anchored frame has an aligning slot, wherein each of the first movable slider and the second movable slider has a protruding structure to slidably engage with the aligning slot of the anchored frame to stack the first movable sliders at one anchored frame and to stack the second movable slider at another anchored frame.

In another preferred embodiment, the anchored frames are detachable that the anchored frames are detachably coupled at the place or opening that needs anti-falling, such as a window frame. The anchored frame are respectively installed on the place that needs anti-falling, such as the top and bottom sides or the left and right sides.

In order to achieve the above objects, the present invention also provides a configurable barrier assembly to be used for installing on the top and bottom sides or the left and right sides of a window frame. Each of the anchored frames comprises at least one anchored rack. The anchored racks are respectively set on both of the top and bottom sides or both of the left and right sides of the window frame. One end of the anti-falling cord is attached on the first movable slider, while the other end is attached on the second movable slider. The first movable sliders slidably sleeve on and stacked at a side of one of the anchored racks, while the second movable sliders slidably sleeve on and stacked at a side of the other anchored rack.

In another preferred embodiment, the anchored racks are integrally set on the top and bottom sides or the left and right sides of the window frame. The anchored rack is a protruding structure, wherein each of the first movable sliders and the second movable sliders has a slot structure to slidably engage with the protruding structure of the anchored rack.

In another preferred embodiment, a plurality of anchored racks are provided to couple at the place that needs anti-falling, such as a window frame, are detachable. The anchored racks are formed in pair at two sides of the window frame and are installed on the top and bottom sides or the left and right sides of the window frame.

Comparing to the art, the configurable barrier assembly of the present invention is mainly to be installed into different places that needs to prevent falling, such as the top and bottom sides or the left and right sides of a window frame of a balcony, patio, or window. An end of the anti-falling cord is attached on the first movable slider, while the other end is attached on the second movable slider. Then, the first movable slider and the second movable slider are formed in pair and are slid and stacked at the anchored frames respectively, so that a user may decide the height of the configurable barrier assembly by himself via a desired numbers of anti-falling cords and the distance between two adjacent cords, so as to achieve the best anti-falling feature. Also, when it becomes unneeded (e.g. when the window is closed), it allows the first movable sliders and the second movable sliders to be selectively removed from the anchored frames in a tool-less manner, so as not to influence the evacuation or view. It makes the users to use the configurable barrier assembly freely, so as to enhance the overall practicability thereof.

Still further objects and advantages will become apparent from a consideration of the ensuing description and drawings.

These and other objectives, features, and advantages of the present invention will become apparent from the following detailed description, the accompanying drawings, and the appended claims.

### BRIEF DESCRIPTION OF THE DRAWINGS

FIG. 1 is an exploded perspective view a configurable barrier assembly according to a first preferred embodiment of the present invention.

FIG. 2 is a perspective view of the configurable barrier assembly according to the above first preferred embodiment the present invention.

FIG. 3 is a top view of the configurable barrier assembly according to the above first preferred embodiment the present invention.

FIG. 4 is an exploded perspective view of the configurable barrier assembly according to a second preferred embodiment the present invention.

FIG. 5 is a perspective view of the configurable barrier assembly according to the above second preferred embodiment the present invention.

FIG. 6 is an exploded perspective view of the configurable barrier assembly according to a third preferred embodiment the present invention.

FIG. 7 is a perspective view of the configurable barrier assembly according to the above third preferred embodiment the present invention.

FIG. 8 is an exploded top view of a configurable barrier assembly according to a fourth preferred embodiment the present invention.

FIG. 9 is a top view of the configurable barrier assembly according to the above fourth preferred embodiment the present invention.

FIG. 10 is an exploded top view of a configurable barrier assembly according to a fifth preferred embodiment the present invention.

FIG. 11 is a top view of the configurable barrier assembly according to the above fifth preferred embodiment the present invention.

### DETAILED DESCRIPTION OF THE PREFERRED EMBODIMENT

The following description is disclosed to enable any person skilled in the art to make and use the present invention. Preferred embodiments are provided in the following description only as examples and modifications will be apparent to those skilled in the art. The general principles defined in the following description would be applied to other embodiments, alternatives, modifications, equivalents, and applications without departing from the spirit and scope of the present invention.

The following describes implementations of the present invention through specific embodiments, so that those who skill in the art can easily understand additional advantages and functions of the present invention through the disclosed contents of the present specification.

The following describes embodiments of the present invention with references of the figures. However, it is worth to mention that these figures are simplified perspective drawings that only apply perspectives for describing basic elements of the present invention, so the figures only demonstrate structures that relate to the present invention rather than illustrate according to actual quantities, shapes, and sizes of the elements for implementations. Formations, quantities, and ratios for each of the elements in actual implementation shall not be limited according to what have shown in the figures, but may be modified based on the needs of actual designs.

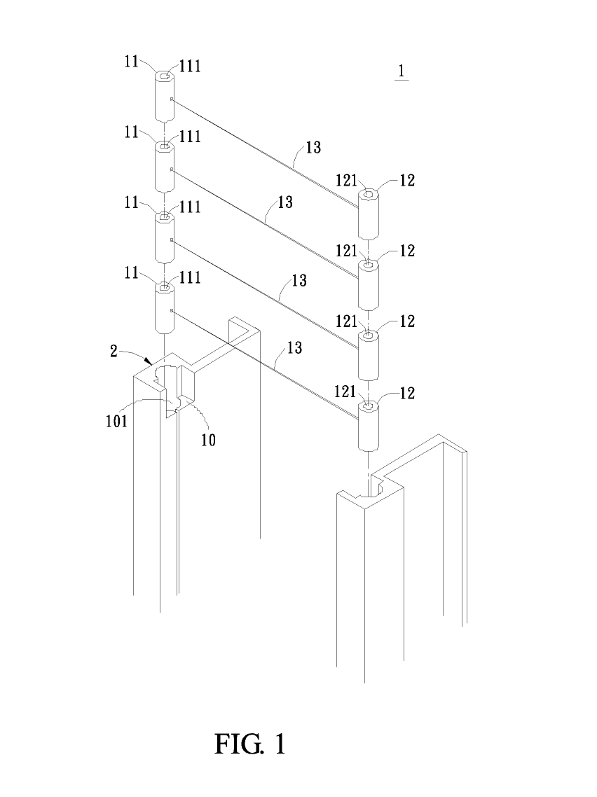

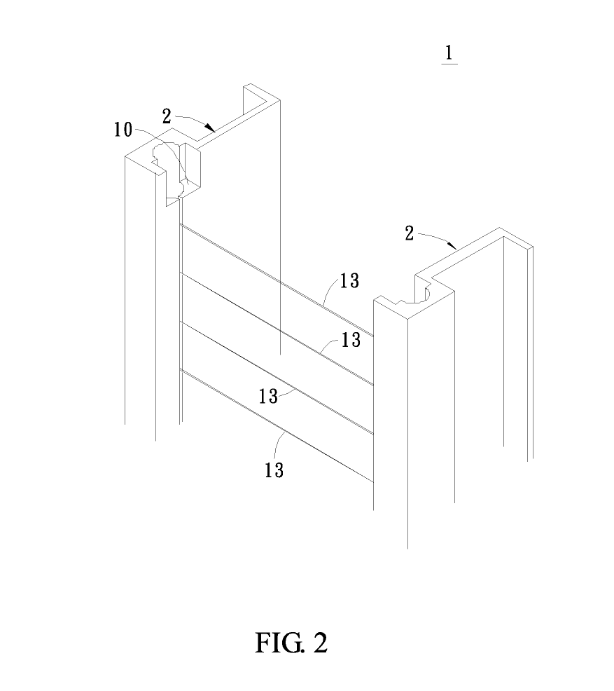

Referring to FIGS. 1 and 2, a configurable barrier assembly 1 according to a first preferred embodiment the present invention is illustrated, wherein the configurable barrier assembly of the present invention, serving as an anti-falling device, can be installed into any place having an opening needed to prevent falling, such as the top and bottom sides or the left and right sides of a window frame 2 of a balcony, patio, or window. The configurable barrier assembly 1 comprises a pair of anchored frames 10, a plurality of first movable sliders 11, a plurality of second movable sliders 12, and a plurality of anti-falling cords 13. In one embodiment, the anchored frames 10 are respectively attached to the left and right sides of the window frame 2. The first movable sliders 11 are aligned at an inner side of one of the anchored frames 10. The second movable sliders 12 are corresponding to the first movable sliders 11 to be aligned at the inner side of another anchored frame 10. Two ends of each of the anti-falling cords 13 are extended between the first movable slider 11 and the second movable slider 12 respectively, as shown in FIG. 1.

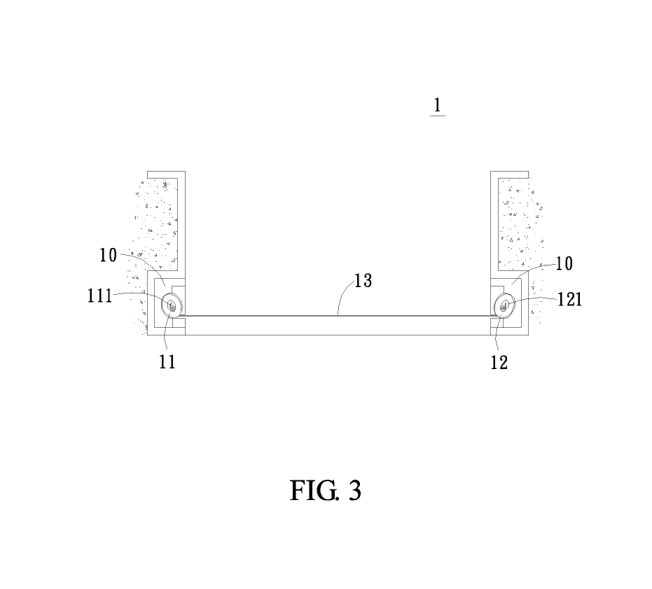

In the above first embodiment, the anchored frames 10 can be integrally set on the left and right sides of the window frame 2, wherein each of the anchored frames 10 has an arch-shaped aligning slot 101 formed at the inner side thereof. The first movable sliders 11 and the second movable sliders 12 are formed in cylindrical shape, wherein each of the first movable sliders 11 and the second movable sliders 12 has a channel 111 and 121 therein. Each of the channels 111 and 121 has a perforation on a side thereof. One end of the anti-falling cord 13 passes through the perforation of the first movable slider 11 and secured within the channel 111 of the first movable slider 11. Then, the other end of the anti-falling cord 13 passes through the perforation of the second movable slider 12 and secured within of the channel 121 of the second movable slider 12, such that the anti-falling cord 13 is coupled between the first movable slider 11 and the second movable slider 12 in a tension manner, as shown in FIG. 3. It is appreciated that the anchored frames 10 may also be attached on the top and bottom sides of the window frame 2 in other embodiments, which shall not be limited in the above mentioned left and right sides.

Based on the above structures, a user may freely decide the quantities of the first movable sliders 11 and the second movable sliders 12. He or she can put an applicable quantity of the first movable sliders 11 and the second movable sliders 12 into the anchored frames 10 at the two inner sides according to his/her needs to extend the anti-falling cords 13 between the inner sides of the anchored frames 10 while the first movable sliders 11 and the second movable sliders 12 are hidden within the aligning slots 101 of the anchored frames 10. It is worth mentioning that inner sides of the anchored frames 10 are facing toward each other. As the first movable sliders 11 and the second movable sliders 12 are slid into the aligning slots 101 one after one to stack the first movable sliders 11 and to stack the second movable sliders 12, the window with a plurality of anti-falling cords 13 extended paralllely will be formed as shown in FIG. 2, so as to achieve the anti-falling feature.

As a user believes that there is no concern about falling (e.g. when the window is locked), he/she can selectively take out the first movable sliders 11 and the second movable sliders 12 respectively from the anchored frames 10, so as to rapidly and easily remove the anti-falling device to not influence the evacuation and the view, which is more convenient to use.

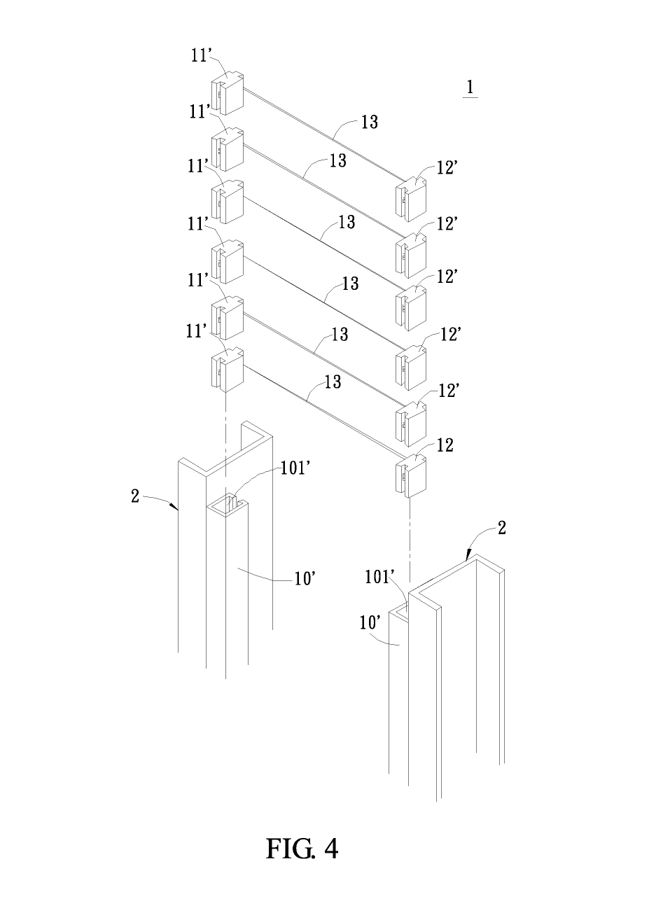

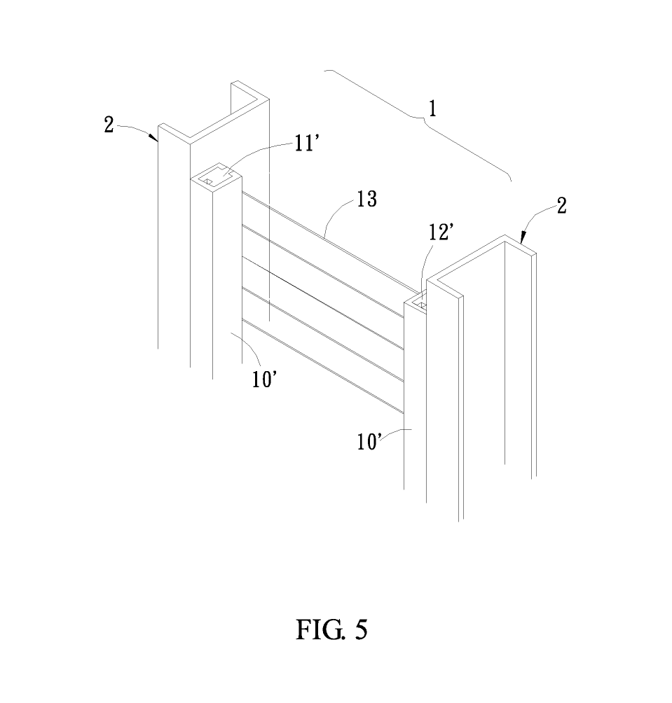

As shown in FIGS. 4 and 5, a configurable barrier assembly 1 of a second embodiment illustrates an alternative mode of the first embodiment, wherein the configurable barrier assembly 1 of the present invention, serving as an anti-falling device, can be installed into any place having an opening needed to prevent falling, such as the top and bottom sides or the left and right sides of a window frame 2 of a balcony, patio, or window. The configurable barrier assembly 1 comprises a pair of anchored frames 10′, a plurality of first movable sliders 11′, a plurality of second movable sliders 12′, and a plurality of anti-falling cords 13. The anchored frames 10′ are respectively attached on the left and right sides of the window frame 2. The first movable sliders 11′ are aligned inside one of the anchored frames 10′ and are slidably at one side thereof. The second movable sliders 12′ are corresponding to the first movable sliders 11′ to be aligned inside the other anchored frame 10′ and are slidable at one side thereof. Two ends of the anti-falling cord 13 are extended between the first movable slider 11′ and the second movable slider 12′, as shown in FIG. 4.

In the above second embodiment, the anchored frame 10′ can be integrally set on the left and right sides of the window frame 2, wherein each of the anchored frame 10′ has a U-shaped aligning slot 101′. Each of the first movable sliders 11′ and the second movable sliders 12′ has a protruding portion coupled to the end of the anti-falling cord 13, wherein the first movable sliders 11′ are slidably stacked at the aligning slots 101′ of one of the anchored frames 10′ and the second movable sliders 12′ are slidably stacked at the aligning slots 101′ of the other anchored frame 10′. It is appreciated that the anchored frames 10′ may also be set on the top and bottom sides of the window frame 2 in other embodiments, which shall not be limited as the above.

Based on the above structures, a user may freely decide the quantities of the first movable sliders 11′ and the second movable sliders 12′. He or she can put an applicable quantity of the first movable sliders 11′ and the second movable sliders 12′ into the anchored frames 10′ at the two inner sides according to his/her needs to extend the anti-falling cords 13 between two interior sides of the anchored frames 10′ while the first movable sliders 11′ and the second movable sliders 12′ are hidden within the aligning slots 101′ of the anchored frames 10′. It is worth mentioning that the interior sides of the anchored frames 10 are facing toward the interior of the building with respect to the installation the window 2. As the first movable sliders 11′ and the second movable sliders 12′ are slid into the aligning slots 101′ one after one to stack the first movable sliders 11′ and to stack the second movable sliders 12′, a window with a plurality of anti-falling cords 13 extended paralllely will be formed as shown in FIG. 5, so as to achieve the anti-falling feature.

As a user believes that there is no concern about falling (e.g. when the window is locked), he/she can selectively take out one or more of the first movable sliders 11′ and one or more of the second movable sliders 12′ respectively from the anchored frames 10′, so as to rapidly and easily remove the anti-falling device to not influence the evacuation and the view, which is more convenient to use.

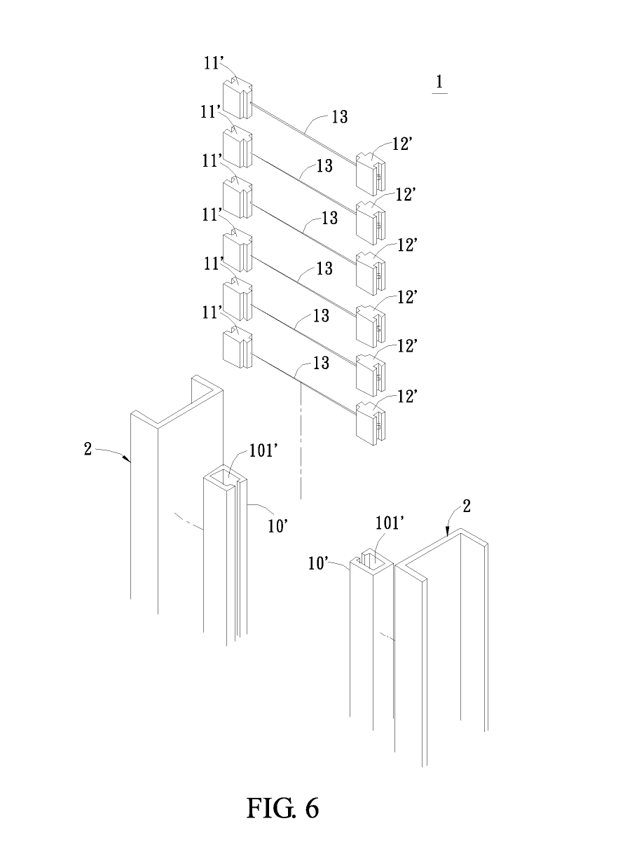

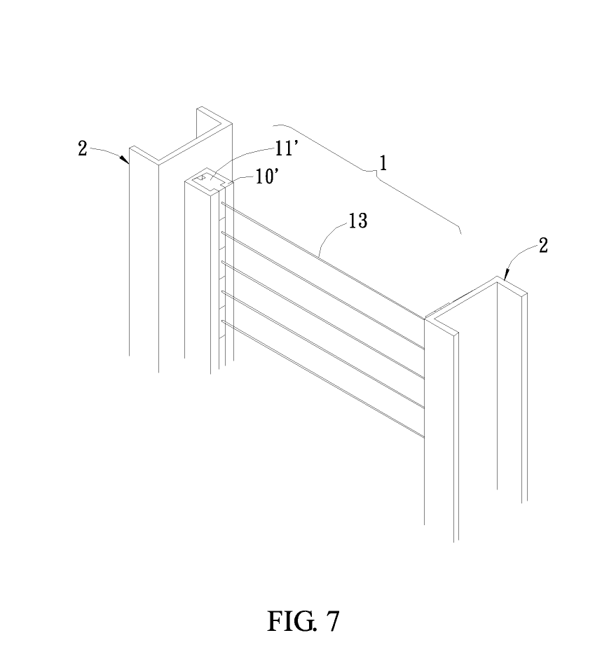

Referring to FIGS. 6 and 7, a configurable barrier assembly 1 of a third embodiment illustrates an alternative mode of the second embodiment, wherein the configurable barrier assembly 1 of the present invention, serving as an anti-falling device, can be installed into any place having an opening needed to prevent falling, such as the top and bottom sides or the left and right sides of a window frame 2 of a balcony, patio, or window. The configurable barrier assembly 1 comprises the anchored frames 10′, the first movable sliders 11′, the second movable sliders 12′, and the anti-falling cords 13. The first movable sliders 11′ are aligned inside one of the anchored frames 10′ and are slidable at one side thereof. The second movable sliders 12′ are corresponding to the first movable sliders 11′ to be aligned inside the other anchored frame 10′ and are slidable at one side thereof. Two ends of the anti-falling cord 13 are extended between the first movable slider 11′ and the second movable slider 12′. This embodiment is a modification of the above second embodiment that the anchored frames 10′ are detachably coupled to the window frame 2, as shown in FIG. 6, to selectively configure the orientation of each of the anchored frames 10′, wherein the anchored frames 10′ are respectively installed (e.g. to be adhered or locked to install) at the places need to prevent falling, such as the left and right sides of a window frame 2.

Also, based on the above structures, a user may freely decide the quantities of the first movable sliders 11′ and the second movable sliders 12′. He or she can put an applicable quantity of the first movable sliders 11′ and the second movable sliders 12′ into the anchored frames 10′ of the two inner sides according to his/her needs to extend the anti-falling cords 13 between two inner sides of the anchored frames 10′ while the first movable sliders 11′ and the second movable sliders 12′ are hidden within the aligning slots 101′ of the anchored frames 10′. It is worth mentioning that the inner sides of the anchored frames 10 are facing toward each other. As the first movable sliders 11′ and the second movable sliders 12′ are slid into the aligning slots 101′ one after one to stack the first movable sliders 11′ and to stack the second movable sliders 12′, a window with a plurality of anti-falling cords 13 extended paralllely will be formed as shown in FIG. 7, so as to achieve the anti-falling feature. Besides, when the user believes that there is no concern about falling (e.g. when the window is locked), he/she can selectively take out one or more of the first movable sliders 11′ and one or more of the second movable sliders 12′ from the anchored frames 10′, so as to rapidly and easily remove the anti-falling device to not influence the evacuation and the view, which is more convenient to use.

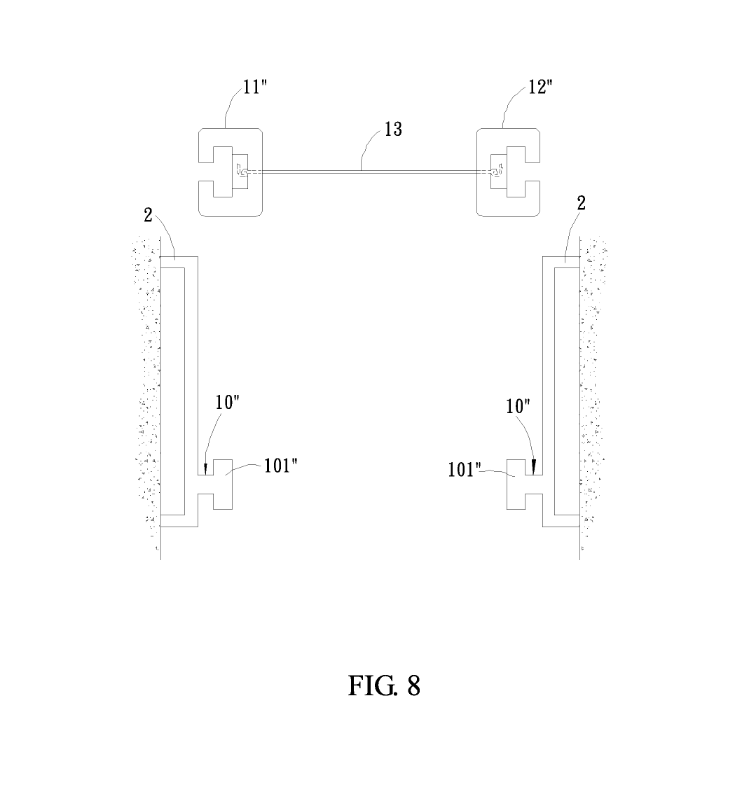

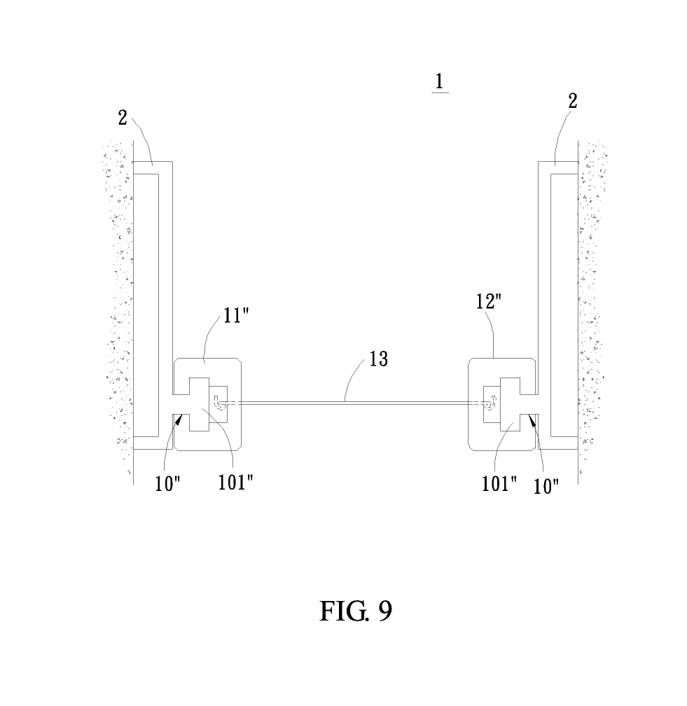

Referring to FIGS. 8 and 9, a configurable barrier assembly 1 of a fourth embodiment illustrates an alternative mode of the first to third embodiments, wherein the configurable barrier assembly 1 of the present invention, serving as an anti-falling device, can be installed into any place having an opening needed to prevent falling, such as the top and bottom sides or the left and right sides of a window frame 2 of a balcony, patio, or window. The configurable barrier assembly 1 comprises two anchored frames 10″, a plurality of C-shaped first movable sliders 11″, a plurality of C-shaped second movable sliders 12″, and a plurality of anti-falling cords 13, wherein each of the anchored frames 10″ forms a T-shaped anchored rack. The anchored frames 10′ are respectively attached on the left and right sides of the window frame 2. The first movable sliders 11″ slidably sleeve on one of the anchored racks 10″. The second movable sliders 12″ are corresponding to the first movable sliders 11″ to slidably sleeve on the other anchored rack 10″. Two ends of the anti-falling cord 13 are extended between the first movable slider 11″ and the second movable slider 12″.

In the above fourth embodiment, the anchored racks 10″ are integrally set on the left and right sides of the window frame 2. In this fourth embodiment, each of the anchored rack 10″ has a protruding structure protruded from the corresponding side of the window frame 2, wherein the anchored rack 10″ has an elongated aligning protruding portion 101″. Each of the first movable sliders 11″ and the second movable sliders 12″ has a slot structure to form a sliding slot and are slidably stacked on the aligning protruding portions 101″ of the anchored racks 10″ respectively. It is appreciated that the anchored racks 10″ are not limited in the structures of being integrated on the window frame 2. In other embodiments, the anchored racks 10″ may also have detachable structures to detachably couple to the window frame 2, which are able to then be installed on the window frame 2 through adhering, locking, or other attaching methods.

Based on the above structures, a user may freely decide the quantities of the first movable sliders 11″ and the second movable sliders 12″. He or she can sleeve an applicable quantity of the first movable sliders 11″ and the second movable sliders 12″ onto of the anchored racks 10″ according to his/her needs to extend the anti-falling cords 13 between two inner sides of the anchored racks 10″. It is worth mentioning that the inner sides of the anchored racks 10″ are facing toward each other. As the first movable sliders 11″ and the second movable sliders 12″ are slid to engage with the aligning protruding portions 101″ of the anchored racks 10″ one after one to stack the first movable sliders 11″ and to stack the second movable sliders 12″, a window with a plurality of anti-falling cords 13 extended paralllely will be formed, so as to achieve the anti-falling feature.

As a user believes that there is no concern about falling (e.g. when the window is locked), he/she can selectively take out one or more the first movable sliders 11″ and one or more of the second movable sliders 12″ respectively from the anchored frames 10″, so as to rapidly and easily remove the anti-falling device to not influence the evacuation and the view, which is therefore more convenient to use.

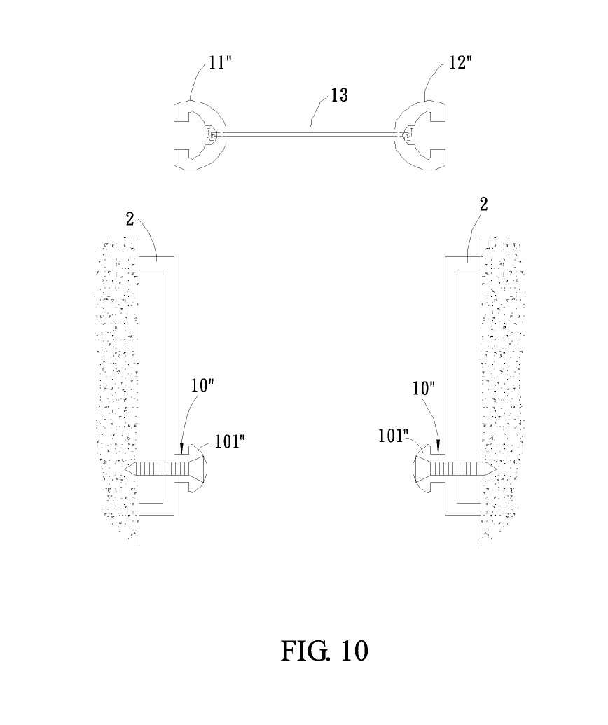

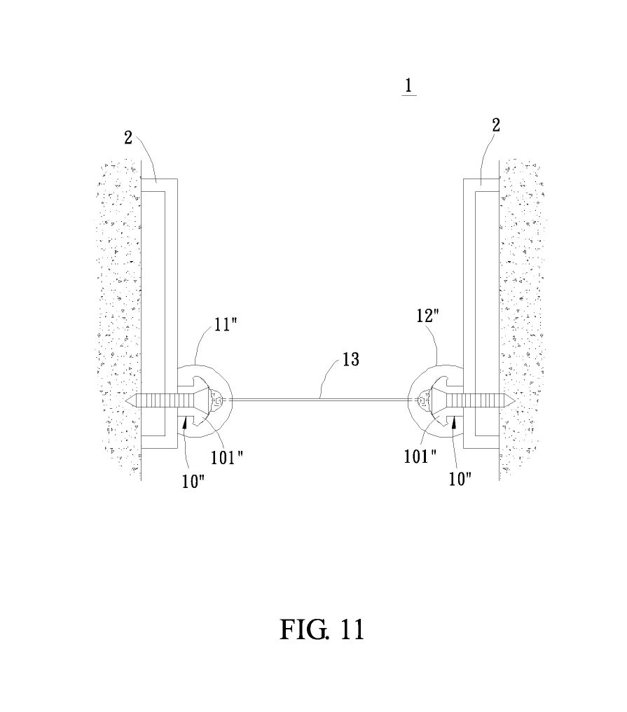

Referring to FIGS. 10 and 11, a configurable barrier assembly 1 of a fifth embodiment illustrates an alternative mode of the fourth embodiment, wherein the configurable barrier assembly 1 of the present invention, serving as an anti-falling device, can be installed into any place having an opening needed to prevent falling, such as the top and bottom sides or the left and right sides of a window frame 2 of a balcony, patio, or window. The configurable barrier assembly 1, like the above third embodiment, a plurality of anchored frames 10″, a plurality of C-shaped first movable sliders 11″, a plurality of C-shaped second movable sliders 12″, and a plurality of anti-falling cords 13, wherein each of the anchored frames 10″ comprises a plurality of screw-shaped anchored racks spacedly coupled at the side of the window frame.

The above fifth embodiment differs from the fourth embodiment in that the anchored racks 10″ are dome shaped tenon structures, wherein each of the first movable sliders 11″ and the second movable slider 12″ has a dome shaped slot corresponding to the tenon structure of each of the anchored racks 10″ which also has a dome shaped head portion 101″ as well. In other words, the screw-shaped anchored rack 10″ is affixed to the corresponding side of the window 2 at a position that the dome shaped head portion 101″ of the screw-shaped anchored rack 10″ is protruded from the corresponding side of the window 2. Therefore, a user may also freely decide the quantities of the first movable sliders 11″ and the second movable sliders 12″. He or she can sleeve an applicable quantity of the first movable sliders 11″ and the second movable sliders 12″ onto the anchored racks 10″ according to his/her needs to extend the anti-falling cords 13 between two inner sides of the anchored racks 10″. It is worth mentioning that the inner sides of the anchored racks 10″ are facing toward each other. As the first movable sliders 11″ and the second movable sliders 12″ are slid to engage with the dome shaped head portion 101″ of the anchored racks 10″ one after one to stack the first movable sliders 11″ and to stack the second movable sliders 12″, a window with a plurality of anti-falling cords 13 extended paralllely will be formed, so as to achieve a good anti-falling effect.

Likewise, as a user believes that there is no concern about falling (e.g. when the window is locked), he/she can selectively take out one or more of the first movable sliders 11″ and one or more of the second movable sliders 12″ respectively from the anchored frames 10″, so as to rapidly and easily remove the anti-falling device to not influence the evacuation and the view, which is therefore more convenient to use.

Comparing to the art, the configurable barrier assembly of the present invention is mainly to be installed into different places that needs to prevent falling, such as the top and bottom sides or the left and right sides of a window frame of a balcony, patio, or window. An end of the anti-falling cord is attached on the first movable slider, while the other end is attached on the second movable slider. Then, the first movable slider and the second movable slider are formed in pair and are slid and stacked at the anchored frames respectively, so that a user may decide the height of the configurable barrier assembly by himself via a desired numbers of anti-falling cords and the distance between two adjacent cords, so as to achieve the best anti-falling feature. Also, when it becomes unneeded (e.g. when the window is closed), it allows the first movable sliders and the second movable sliders to be selectively removed from the anchored frames in a tool-less manner, so as not to influence the evacuation or view. It makes the users to use the configurable barrier assembly freely, so as to enhance the overall practicability thereof.

Although the above descriptions and figures have disclosed preferred embodiments of the present invention, it shall be noticed that there are all kinds of adding, many modifications, and substitutions can be used in the preferred embodiments of the present invention, but still be within the scope and spirit of the principles of the present invention defined in the appended claims. Those who skill in the art of the field of the present invention should understand that the present invention can be modified in many forms, structures, settings, ratios, materials, elements, and components. Hence, the embodiments disclosed herein in the present specification shall be considered describing the present invention, rather than limiting the present invention. The scope of the present invention shall be defined by the appended claims and include the legal equivalents thereof, which is not limited within the above descriptions.

One skilled in the art will understand that the embodiment of the present invention as shown in the drawings and described above is exemplary only and not intended to be limiting.

It will thus be seen that the objects of the present invention have been fully and effectively accomplished. The embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. A configurable barrier assembly for a window frame or the like, comprising:
at least two anchored frames adapted for being installed on the two sides of the window frame respectively;
a plurality of first movable sliders slidably coupled at one of said anchored frames in a detachably movable manner;
a plurality of second movable sliders slidably coupled at another said anchored frame in a detachably movable manner, wherein said first movable sliders and said second movable sliders are formed in pair; and
a plurality of anti-falling cords, wherein each of said anti-falling cords is extended between said first movable slider and said second movable slider in each pair, such that said anti-falling cords are extended between said anchored frames in a tension manner to form a barrier.

2. The configurable barrier assembly, as recited in claim 1, wherein said anchored frames are integrally formed with the sides of the window frame.

3. The configurable barrier assembly, as recited in claim 1, wherein said first movable slider and said second movable slider are formed in cylindrical shape, wherein each of said first movable sliders and the second movable sliders has a channel formed therewithin and a perforation on a side thereof.

4. The configurable barrier assembly, as recited in claim 3, wherein an end of said anti-falling cord passes through said perforation of said first movable slider and is secured in said channel thereof, wherein another end of said anti-falling cord passes through said perforation of said second movable slider and is secured in said channel thereof.

5. The configurable barrier assembly, as recited in claim 1, wherein said anchored frames are detachably coupled at the sides of the window frame.

6. The configurable barrier assembly, as recited in claim 1, wherein said anchored frame has an aligning slot.

7. The configurable barrier assembly, as recited in claim 6, wherein each of said first movable sliders and said second movable sliders has a protruding portion to slidably engage with said aligning slot of said anchored frame.

8. The configurable barrier assembly, as recited in claim 1, wherein each of said anchored frames comprises a T-shaped anchored rack coupled at the side of the window frame to define a protruding portion of said T-shaped anchored rack protruded from the corresponding side of the window, wherein said first movable sliders and said second movable sliders are slidably sleeved and stacked at said protruding portions of said anchored racks respectively.

9. The configurable barrier assembly, as recited in claim 8, wherein each of said first movable sliders and said second movable sliders has a C-shape defining a slot thereat to slidably engage with said protruding portion of said T-shaped anchored rack.

10. The configurable barrier assembly, as recited in claim 1, wherein each of said anchored frames comprises a plurality of screw-shaped anchored racks spacedly coupled at the side of the window frame and each defines a dome shaped head portion of said screw-shaped anchored rack protruded from the corresponding side of the window, wherein said first movable sliders and said second movable sliders are slidably sleeved and stacked at said dome shaped head portions of said anchored racks respectively.

11. The configurable barrier assembly, as recited in claim 8, wherein each of said first movable sliders and said second movable sliders has a C-shape defining a dome shaped slot thereat to slidably engage with said dome shaped head portion of said anchored rack.
